(19) United States
(12) Patent Application Publication
(10) Pub. No.: US 2015/0047032 A1
(43) Pub. Date: Feb. 12, 2015

(54) SYSTEM AND METHOD FOR COMPUTER SECURITY

(71) Applicant: Front Porch Communications, Inc., Lexington, AL (US)

(72) Inventors: Greg Hannis, Pompano Beach, FL (US); Dennis Nadeau, Pompano Beach, FL (US); Francisco Guerrra, Lexington, AL (US)

(21) Appl. No.: 13/961,244

(22) Filed: Aug. 7, 2013

(51) Int. Cl. H04L 29/06

(52) U.S. Cl. CPC H04L 63/1416
USPC 726/23

(57) ABSTRACT

A system and method for providing computer network security, including providing programs on a non-transitory computer readable medium, configuring said programs with an actuation threshold, actuating the programs in a manner to direct an unauthorized user to at least one pre-selected file of said network, forming at least one computer system decoy, and notifying an authorized computer user of the actuation of the program.

### BACKGROUND OF THE INVENTION

An Intrusion Detection Systems (IDS) is a device or software application that monitors network and/or system activities for malicious activities or policy violations and produces reports to a Management Station. Intrusion prevention is the process of performing intrusion detection in an attempt to stop unauthorized access that exploit weaknesses in networks, an application or an operating system's software. Intrusion detection and prevention systems (IDPS) are primarily focused on identifying possible incidents, logging information about them, attempting to stop them, and reporting them to security administrators. In addition, organizations use IDPS for other purposes, such as identifying problems with security policies, documenting existing threats, and deterring individuals from violating security policies. IDPS have become a necessary addition to the security infrastructure of nearly every organization.

IDPS typically record information related to observed events, notify security administrators of important observed events, and produce reports. Many IDPS can also respond to a detected threat by attempting to prevent it from succeeding. They use several response techniques, which involve the IDPS stopping the attack itself, changing the security environment (e.g., reconfiguring a firewall), or changing the attack's content.

An Intrusion Detection System (IDS) is a device or software application that monitors computer networks and/or system activities for malicious activities or policy violations and produces reports to a Management Station. Intrusion prevention is the process of performing intrusion detection and attempting to stop detected possible incidents. Intrusion detection and prevention systems (IDPS) are primarily focused on identifying possible incidents, logging information about them, attempting to stop them, and reporting them to security administrators. In addition, organizations use IDPSs for other purposes, such as identifying problems with security policies, documenting existing threats, deterring individuals from violating security policies and protect from a skilled insider looking to steal valuable information.

Intrusion detection systems are software of hardware product that automates those monitoring and analysis processes. Hence IDS can help us from attacking malwares, poisonous programs, and security threats, finally a total protection can be accomplished by IDS.

IDS, allows organizations to protect their systems from threats that come with increasing network connectivity and reliance on information systems. There are some questions including system protections that cannot be answered by our firewall, e.g. modem protection or protection of the firewall itself.

There are several compelling reasons to acquire and use IDSs:
To prevent the problem behavior by increasing the perceived risk of discovery and punishment for those who would attack or otherwise abuse the system
To detect attacks and other security violations that are not prevented by other security measures
To detect and deal with preambles to attacks
To document the existing threats to an organization
To provide useful information about intrusion and its impact on the network and your system, allowing improved diagnosis, recovery and correction of causative factors.

### Intrusion Detection System Versus Firewall Hardware or Software

IDS are a dedicated assistant used to monitor the rest of the security infrastructure.
Today's security infrastructures are becoming extremely complex; it includes firewalls, identification and authentication systems, access control product, virtual private networks, encryption products, virus scanners, software and more. All of these tools and or software perform functions essential to system security. Given their role they are also prime targets and being managed by humans, as such they are prone to errors.
Failure of one of the above components of your security infrastructure can jeopardize the system they are supposed to protect.
Not all traffic may go through a firewall i.e. modem on a user computer
Additionally, not all threats originate from the outside. As networks use more and more encryption, attackers will aim for locations where it is often stored unencrypted (Internal network)
Firewalls do not protect adequately against all application level weaknesses, DDoS and other system attacks.
Firewalls are subject to attacks themselves and do not protect against misconfigurations or other human error faults in other security mechanisms

### Advantages of IDS

Monitor and analyze user and system activities;
Auditing of system and configuration vulnerabilities;
Assess integrity of critical system and data files;
Recognition of patterns reflecting known attacks;
Statistical analysis for abnormal activities; and
Data trail, tracing activities from point of entry up to the point of exit.

### Limitations of IDS

Compensate for weak authentication and identification mechanisms;
Investigate attacks without human intervention;
Guess the content of your organization security policies;
Compensate for weakness in networking protocols, for example: IP Spoofing;
Compensate for integrity or confidentiality of information;
Analyze all traffic on a very high speed network;
Deal adequately with attack at the packet level; and
Deal adequately with modern network hardware;

There are nine main types of Intrusion Detection Systems:
Active and Passive
Knowledge-based and behavior-based IDS
Host Based (HIDS)
Network Based (NIDS)
Application based

### Active IDS

An active IDS (now more commonly known as an intrusion prevention system—IPS) is a system that's configured to automatically block suspected attacks in progress without any intervention required by an operator. IPS has the advantage of providing real-time corrective action in response to an attack but has many disadvantages as well. An IPS must be placed in-line along a network boundary; thus, the IPS itself is susceptible to attack. Also, if false alarms and legitimate traffic haven't been properly identified and filtered, authorized users and applications may be improperly denied access. Finally, the IPS itself may be used to effect a Denial of Service (DoS) attack by intentionally flooding the system with alarms that cause it to block connections until no connections or bandwidth are available.

### Passive IDS

A passive IDS is a system that's configured only to monitor and analyze network traffic activity and alert an operator to potential vulnerabilities and attacks. It isn't capable of performing any protective or corrective functions on its own. The major advantages of passive IDSes are that these systems can be easily and rapidly deployed and are not normally susceptible to attack themselves.

### Knowledge-Based and Behavior-Based IDS

A knowledge-based (or signature-based) IDS references a database of previous attack profiles and known system vulnerabilities to identify active intrusion attempts. Knowledge-based IDS is currently more common than behavior-based IDS. Advantages of knowledge-based systems include the following:

It has lower false alarm rates than behavior-based IDS. Alarms are more standardized and more easily understood than behavior-based IDS.

Disadvantages of knowledge-based systems include these:

Signature database must be continually updated and maintained.

New, unique, or original attacks may not be detected or may be improperly classified.

A behavior-based (or statistical anomaly-based) IDS references a baseline or learned pattern of normal system activity to identify active intrusion attempts. Deviations from this baseline or pattern cause an alarm to be triggered. Advantages of behavior-based systems include that they

Dynamically adapt to new, unique, or original attacks.

Are less dependent on identifying specific operating system vulnerabilities.

Disadvantages of behavior-based systems include

Higher false alarm rates than knowledge-based IDSes. Usage patterns that may change often and may not be static enough to implement an effective behavior-based IDS.

### Host Based IDS

Intrusion Detection Systems are installed on a host in the network. HIDS collects and analyzes the traffic that is originated or is intended for that host. HIDS leverages their privileged access to monitor specific components of a host that are not readily accessible to other systems. Specific components of the operating system such as password files in UNIX and the Registry in Windows can be watched for misuse. There is great risk in making these types of components available to NIDS to monitor.

In most cases, a Host Intrusion Detection System (HIDS) component is made up of two parts: a centralized manager and a server agent. The manager is used to administer and store policies, download policies to agents and store information received by agents. The agent is installed onto each server and registered with the manager. Agents use policies to detect and respond to specific events and attacks. An example of a policy would be an agent that sends an SNMP trap when three concurrent logins as root have failed on a UNIX server. System logs and processes are also monitored to see if any actions that violate the policy have occurred. If a policy has been violated, the agent will take a predefined action such as sending an email or sending a SNMP trap to a network management system. Host based intrusion detection system may further be divided into: System integrity verifiers (SIV): these monitor system files to find when an intruder changes them (thereby leaving behind a backdoor). The most famous of such systems is “Tripwire”. A SIV may watch other components as well, such as the Windows registry and cron configuration, in order to find well known signatures. It may also detect when a normal user somehow acquires root/administrator level privileges. Many existing products in this area should be considered more “tools” than complete “systems”: i.e. something like “Tripwire” detects changes in critical system components, but doesn't generate real-time alerts upon an intrusion.

Log file monitors (LFM): these monitor log files generated by network services. In a similar manner to NIDS, these systems look for patterns in the log files that suggest an intruder is attacking. A typical example would be a parser for HTTP server log files that are looking for intruders who try well-known security holes, such as the “phf” attack. Example: swatch

Although HIDS is far better than NIDS in detecting malicious activities for a particular host, they have a limited view of entire network topology and they cannot detect an attack that is targeted for a host in a network which does not have HIDS installed.

### Advantages of Host Based IDS

Host based IDSs, with their ability to monitor events local to a host, can detect attacks that cannot be seen by network based IDS.
Host based IDSs can often operate in an environment in which network traffic is encrypted, when host based information sources are generated before data is encrypted at the destination host.
Host based IDSs are unaffected by switched network.
When host based IDSs operate on OS audit trails, they can help detect Trojan horse or other attacks that involve software integrity.

### Disadvantages of Host Based IDS

Host based IDSs are harder to manage, as information must be configured and managed for every host monitored
Since at least the information sources (and sometimes part of analysis engines) for host based IDSs reside on the host targeted by attacks, the IDSs may be attacked and disabled as part of the attack.
Host based IDSs are not well suited for detecting network scans or other such surveillance that target an entire network, because the IDS only see those network packets received by its host.
Host-based IDSs can be disabled by certain denial-of-service attacks.
When host-based IDSs use operating system audit trails as an information source, the amount of information can be immense, requiring additional local storage on the system.
Host based IDSs use the computing resources of the host they are monitoring, therefore inflicting a performance cost on the monitored system.

### Network Based IDS

Network IDSs (NIDS) are placed in key areas of network infrastructure and monitor the traffic as it flows to other host. Unlike HIDS, NIDS have the capability of monitoring the network and detecting the malicious activities intended for that network. Monitoring criteria for a specific host in the network can be increased or decreased with relative ease.

Network Intrusion Detection systems (NIDS) transparently monitor network traffic, looking for patterns indicative of an attack on a computer or network device. By examining the network traffic, a network based intrusion detection system can detect suspicious activity such as a port scan or Denial of Service (DOS) attacks.

A NIDS monitors the network traffic it has access to, by comparing the data in the TCP/IP packet to a database of attack signatures. In a network environment, it can see packets to and from the system(s) that it monitors. In a switched environment, it can see packets coming to and from the system(s) that it monitors, providing it can see all data traffic on the ports that connect to the systems. Once a NIDS detects an attack, the following actions may be taken:
Send email notification
Send an SNMP trap to a network management system
Send a page (to a pager)
Block a TCP connection
Kill a TCP connection
Run a user defined script

In general terms a NIDS will be deployed on a DMZ. This assumes that you have a firewall in place and that you have a DMZ configured. When deployed behind the firewalls, the NID will detect attacks from protocols and sources allowed through the firewall and from internal users. By taking an action, such as sending an SNMP trap or a page, it can alert network staff that an attack is in progress and enable them to make decisions based on the nature of the attack. It is recommended that the IDS is used for detection and alerting only and not for proactive defense i.e. killing/blocking TCP connections as this can often cause more problems.

NIDS should be capable of standing against large amounts of network traffic to remain effective. As network traffic increases exponentially NIDS must grab all of the traffic and analyze in a timely manner.

### Advantages of NIDS

A few well-placed network-based IDS can monitor a large network.
The deploying of NIDS have little impact upon an existing network. NIDS are usually passive devices that listen on a network wire without interfering with the normal operation of a network. Thus; it is usually easy to retrofit a network to include NIDS with minimal effort.
NIDS can be made very secure against attack and even made invisible to many attackers.

### Disadvantages of NIDS

NIDS may have difficulty possessing all packets in a large or busy network and, therefore, may fail to recognize an attack launched during period of high traffic. Some vendors are attempting to solve this problem by implementing IDS completely in hardware, which is much faster. The need to analyze packets quickly also forces vendors to detect both fewer attacks and also detect attacks with as little computing as possible which can reduce detection effectiveness.
Many advantages of NIDS do not apply to more modern switch-based networks. Switches subdivide networks into many small segments and provide dedicated links between hosts serviced by the same switch. Most switches do not provide universal monitoring ports and this limits the monitoring range of a NIDSs systems sensor to a single host. Even when switches provide such monitoring ports, often the single port cannot mirror all traffic traversing the switch.
NIDSs cannot analyze encrypted information. This problem is increasing as more organizations (and attackers) use virtual private networks.
Most NIDS cannot tell whether or not an attack was successful; they can only discern that an attack was initiated. This means that after NIDS detects an attack, an administrator must manually investigate each attacked host to determine whether it was indeed penetrated.

### Application Based IDS

Application protocol-based intrusion detection systems (APIDS) is an intrusion detection system that focuses its monitoring and analysis on a specific application protocol or protocols in use by the computing system. An APIDS will monitor the dynamic behavior and state of the protocol and will typically consist of a system or agent that would sit between a process, or group of servers, monitoring and analyzing the application protocol between two connected devices. A typical place for an APIDS would be between a web server and the database management system, monitoring the SQL protocol specific to the middleware/business logic as it interacts with the database.

### Monitoring Dynamic Behavior

At a basic level an APIDS would look for, and enforce, the correct (legal) use of the protocol. However at a more advanced level the APIDS can learn, be taught or even reduce what is often an infinite protocol set, to an acceptable understanding of the subset of that application protocol that is used by the application being monitored and protected.

Thus, an APIDS, correctly configured, will allow an application to be “fingerprinted”, thus should that application be subverted or changed, so will the fingerprint change.

### Advantages of Monitoring Dynamic Behavior

An application protocol-based intrusion detection system can monitor the interaction between user and application, which often allows them to trace unauthorized activity to individual users.
An application protocol-based intrusion detection system can often work in encrypted environment, since they interface with the applications at the transaction end points, where the information is presented to users in unencrypted form.

### Disadvantages of Monitoring Dynamic Behavior

An application protocol-based intrusion detection system may be more vulnerable than host-based IDS to attack as the application logs are not as well protected as the operating system audit trails used for host based IDS.
As an application protocol-based intrusion detection system often monitors events at the user level of abstraction, they cannot detect Trojan horse or other such software tampering attacks. Therefore, it is advisable to use Application based IDS in combination with Host based IDS or network based IDS.

### Other Types of IDS

There are other types of IDS can be explained, these are:

### Stack Based IDS

Stack based IDS is latest technology, which works by integrating closely with the TCP/IP stack, allowing packets to be watched as they traverse their way up the OSI layers. Watching the packet in this way allows the IDS to pull the packet from the stack before the OS or application has a chance to process the packets.

### Signature-Based IDS

Signature-Based IDS use a rule set to identify intrusions by watching for patterns of events specific to known and documented attacks. It is typically connected to a large database which houses attack signatures. It compares the information it gathers against those attack signatures to detect a match.

These types of systems are normally presumed to be able to detect only attacks “known” to its database. Thus, if the database is not updated with regularity, new attacks could slip through. It can, however, detect new attacks that share characteristics with old attacks, e.g., accessing ‘cmd.exe’ via a HTTP GET request. But, in cases of new, un-cataloged attacks, this technique is pretty porous.

Also, signature based IDS's may affect performance in cases when intrusion patterns match several attack signatures. In cases such as these, there is a noticeable performance lag. Signature definitions stored in the database need to be specific so that variations on known attacks are not missed. This sometimes leads to building up of huge databases which eat up a chunk of space.

### Anomaly Based IDS

Anomaly-Based IDS examines ongoing traffic, activity, transactions and behavior in order to identify intrusions by detecting anomalies. It works on the notion that “attack behavior” differs enough from “normal user behavior” such that it can be detected by cataloging and identifying the differences involved. These systems cannot compare alternative architectures in order to try to identify true positive and false positives.

In most anomaly-based IDS's, the system administrator defines the baseline of normal behavior. This includes the state of the network's traffic load, breakdown, protocol, and typical packet size. Anomaly detectors monitor network segments to compare their state to the normal baseline and look for current behaviors which deviate statistically from the normal. This capability theoretically gives anomaly-based IDSs abilities to detect new attacks that are neither known, nor for which signatures have been created. On the other hand, anomaly-based IDS systems have been known to be prone to a lot of false positives. In these cases, the attacks are reported based on changes to the current system on which the IDS is installed. This is because there is a change in the normal state of the system which is not perceived by the IDS.

Sometimes, anomaly-based IDS systems can cause heavy processing overheads on the computer system they are installed on. It takes a short period of time for anomaly-based systems to create statistically significant baselines. During this period, they are relatively open to attack.

IDS use a number of different technologies to detect malicious activity. The three most widely distributed technologies are signature detection, behavioral anomaly detection, and protocol anomaly detection.

### Types of Computer Attacks Commonly Detected by IDS

### Scanning Attack:

A scanning attack is a particular type of BRUTE FORCE ATTACK on a computer system. It involves the use of a program known as a WAR DIALER. This generates a large number of sequences of characters that could be telephone numbers or passwords. A typical scanning attack would involve the program being set up to dial a long series of telephone numbers; any numbers giving some indication of a modem being used are stored. After a scanning session an intruder dials these numbers and attempts to break in using a variety of techniques including trying well-known passwords.

### Port Scan Attack

Port Scan attack refers to scan TCP/UDP ports to discover services they can break into. All machines connected to a LAN or connected to Internet via a modem run many services that listen at well-known and not so well-known ports. By port scanning the attacker finds which ports are available (i.e., being listened to by a service). Essentially, a port scan consists of sending a message to each port, one at a time. The kind of response received indicates whether the port is used and can therefore be probed further for weakness.

### A Denial-of-Service Attack

Denial-of-Service attack (DoS attack) or distributed denial-of-service attack (DDoS attack) is an attempt to make a computer resource unavailable to its intended users. Although the means to carry out, motives for, and targets of a DoS attack may vary, it generally consists of the concerted efforts of a person or people to prevent an Internet site or service from functioning efficiently or at all, temporarily or indefinitely. Perpetrators of DoS attacks typically target sites or services hosted on high-profile web servers such as banks, credit card payment gateways, and even root nameservers. The term is generally used with regards to computer networks, but is not limited to this field, for example, it is also used in reference to CPU resource management.

One common method of attack involves saturating the target (victim) machine with external communications requests, such that it cannot respond to legitimate traffic, or responds so slowly as to be rendered effectively unavailable. In general terms, DoS attacks are implemented by either forcing the targeted computer(s) to reset, or consuming its resources so that it can no longer provide its intended service or obstructing the communication media between the intended users and the victim so that they can no longer communicate adequately.

Denial-of-service attacks are considered violations of the IAB's Internet proper use policy, and also violate the acceptable use policies of virtually all Internet service providers. They also commonly constitute violations of the laws of individual nations.

### Peer-to-Peer Attacks

Attackers have found a way to exploit a number of bugs in peer-to-peer servers to initiate DDoS attacks. The most aggressive of these peer-to-peer-DDoS attacks exploits DC++. Peer-to-peer attacks are different from regular botnet-based attacks. With peer-to-peer there is no botnet and the attacker does not have to communicate with the clients it subverts. Instead, the attacker acts as a ‘puppet master,’ instructing clients of large peer-to-peer file sharing hubs to disconnect from their peer-to-peer network and to connect to the victim's website instead. As a result, several thousand computers may aggressively try to connect to a target website. While a typical web server can handle a few hundred connections/sec before performance begins to degrade, most web servers fail almost instantly under five or six thousand connections/sec. With a moderately big peer-to-peer attack a site could potentially be hit with up to 750,000 connections in a short order. The targeted web server will be plugged up by the incoming connections. While peer-to-peer attacks are easy to identify with signatures, the large number of IP addresses that need to be blocked (often over 250,000 during the course of a big attack) means that this type of attack can overwhelm mitigation defenses. Even if a mitigation device can keep blocking IP addresses, there are other problems to consider. For instance, there is a brief moment where the connection is opened on the server side before the signature itself comes through. Only once the connection is opened to the server can the identifying signature be sent and detected, and the connection torn down. Even tearing down connections takes server resources and can harm the server.

This method of attack can be prevented by specifying in the p2p protocol which ports are allowed or not. If port 80 is not allowed, the possibilities for attack on websites can be very limited.

### Permanent Denial-of-Service Attacks

A permanent denial-of-service (PDoS), also known loosely as phlashing, is an attack that damages a system so badly that it requires replacement or reinstallation of hardware.[9] Unlike the distributed denial-of-service attack, a PDoS attack exploits security flaws which allow remote administration on the management interfaces of the victim's hardware, such as routers, printers, or other networking hardware. The attacker uses these vulnerabilities to replace a device's firmware with a modified, corrupt, or defective firmware image—a process which when done legitimately is known as flashing. This therefore “bricks” the device, rendering it unusable for its original purpose until it can be repaired or replaced.

The PDoS is a pure hardware targeted attack which can be much faster and requires fewer resources than using a botnet in a DDoS attack. Because of these features, and the potential and high probability of security exploits on Network Enabled Embedded Devices (NEEDs), this technique has come to the attention of numerous hacker communities. PhlashDance is a tool created by Rich Smith (an employee of Hewlett-Packard's Systems Security Lab) used to detect and demonstrate PDoS vulnerabilities at the 2008 EUSecWest Applied Security Conference in London.

### Teardrop Attacks

A Teardrop attack involves sending mangled IP fragments with overlapping, over-sized payloads to the target machine. This can crash various operating systems due to a bug in their TCP/IP fragmentation re-assembly code. Windows 3.1x, Windows 95 and Windows NT operating systems, as well as versions of Linux prior to versions 2.0.32 and 2.1.63 are vulnerable to this attack.

Around September 2009, a vulnerability in Vista was referred to as a “teardrop attack”, but the attack targeted SMB2 which is a higher layer than the TCP packets that teardrop used

### Distributed Attack

A distributed denial of service attack (DDoS) occurs when multiple systems flood the bandwidth or resources of a targeted system, usually one or more web servers. These systems are compromised by attackers using a variety of methods.

Malware can carry DDoS attack mechanisms; one of the better-known examples of this was MyDoom. Its DoS mechanism was triggered on a specific date and time. This type of DDoS involved hardcoding the target IP address prior to release of the malware and no further interaction was necessary to launch the attack.

A system may also be compromised with a trojan, allowing the attacker to download a zombie agent (or the trojan may contain one). Attackers can also break into systems using automated tools that exploit flaws in programs that listen for connections from remote hosts. This scenario primarily concerns systems acting as servers on the web.

Stacheldraht is a classic example of a DDoS tool. It utilizes a layered structure where the attacker uses a client program to connect to handlers, which are compromised systems that issue commands to the zombie agents, which in turn facilitate the DDoS attack. Agents are compromised via the handlers by the attacker, using automated routines to exploit vulnerabilities in programs that accept remote connections running on the targeted remote hosts. Each handler can control up to a thousand agents.

These collections of systems compromisers are known as botnets. DDoS tools like stacheldraht still use classic DoS attack methods centered on IP spoofing and amplification like smurf attacks and fraggle attacks (these are also known as bandwidth consumption attacks). SYN floods (also known as resource starvation attacks) may also be used. Newer tools can use DNS servers for DoS purposes. See next section.

Simple attacks such as SYN floods may appear with a wide range of source IP addresses, giving the appearance of a well distributed DDoS. These flood attacks do not require completion of the TCP three way handshake and attempt to exhaust the destination SYN queue or the server bandwidth. Because the source IP addresses can be trivially spoofed, an attack could come from a limited set of sources, or may even originate from a single host. Stack enhancements such as syn cookies may be effective mitigation against SYN queue flooding, however complete bandwidth exhaustion may require involvement

It is important to note the difference between a DDoS and DoS attack. If an attacker mounts an attack from a single host it would be classified as a DoS attack. In fact, any attack against availability would be classed as a Denial of Service attack. On the other hand, if an attacker uses a thousand systems to simultaneously launch smurf attacks against a remote host, this would be classified as a DDoS attack.

The major advantages to an attacker of using a distributed denial-of-service attack are that multiple machines can generate more attack traffic than one machine, multiple attack machines are harder to turn off than one attack machine, and that the behavior of each attack machine can be stealthier, making it harder to track down and shut down. These attacker advantages cause challenges for defense mechanisms. For example, merely purchasing more incoming bandwidth than the current volume of the attack might not help, because the attacker might be able to simply add more attack machines

### Reflected Attack

A distributed reflected denial of service attack (DRDoS) involves sending forged requests of some type to a very large number of computers that will reply to the requests.

Using Internet protocol spoofing, the source address is set to that of the targeted victim, which means all the replies will go to (and flood) the target.

ICMP Echo Request attacks (Smurf Attack) can be considered one form of reflected attack, as the flooding host(s) sends Echo Requests to the broadcast addresses of misconfigured networks, thereby enticing many hosts to send Echo Reply packets to the victim. Some early DDoS programs implemented a distributed form of this attack.

Many services can be exploited to act as reflectors, some harder to block than others. DNS amplification attacks involve a new mechanism that increased the amplification effect, using a much larger list of DNS servers than seen earlier.

### Degradation-of-Service Attacks

“Pulsing” zombies are compromised computers that are directed to launch intermittent and short-lived flooding of victim websites with the intent of merely slowing it rather than crashing it. This type of attack, referred to as “degradation-of-service” rather than “denial-of-service”, can be more difficult to detect than regular zombie invasions and can disrupt and hamper connection to websites for prolonged periods of time, potentially causing more damage than concentrated floods. Exposure of degradation-of-service attacks is complicated further by the matter of discerning whether the attacks really are attacks or just healthy and likely desired increases in website traffic.

### Penetration Attacks

Penetration attacks involves the unauthorized acquisition of and/alternation of the system privileges, resources, or data. Consider these integrity control violations as contrasted to DOS attacks, which don't do any illegal. A penetration attack can gain control of a system by exploiting a variety of software flaws. The most common flaws and the security consequences of each are explained and enumerated below. While penetration attacks very tremendously in detail and impact, the common types are:

User to root: a local user on host gains complete control of the target host

Remote to user: an attacker on the network gains access to a user account on the target host.

Remote to root: an attacker on the network gains access to a user account on the target host.

Remote disk read: an attacker on the network gains the ability to read private data files on the target host without the authorization of the owner.

Remote disk write: An attacker on the network gains the ability to write to private data files on the target host without the authorization of the owner.

Determining Attacker Location from IDS Output

In notification of detected attacks, IDSs will often report the location of attacker. This location is most commonly expressed as a source IP address. The reported address is simply the source address that attack on the attack packets, this doesn't necessarily represent the true source address of the attacker. The key to determining the significance of the reported source IP address is to classify the type of attack and then determine whether or not the attacker needs to see the reply packet sent by the victim. If the attacker launches a one-way attack, like many flood DOS attack, where the attacker does not need to see any reply packets, then the attacker can label his packets with random IP addresses. The attacker is doing the real world equivalent of sending a postcard with a fake return address to fill a mailbox so that no other mail can fit into it. In this case, the attacker cannot receive any reply from the victim. However the attacker needs to view the victims' replies, which is usually true with penetration attacks, then the attacker usually cannot lie about his source IP address. Using the postcard analogy, the attacker needs to know that his postcards go to the victim and therefore must usually label his postcards with his actual address. In general, attacker must use the correct IP address when launching penetration attack but not with DOS attacks. However, there exists one caveat when dealing with expert attackers. An attacker can send attack packets using a source IP address, but arrange to wiretap the victims reply to the faked address. The attacker can do this without having access to the computer at the fake address. This manipulation of IP address is called “IP spoofing”.

### Strength and Limitations of IDSs

Although Intrusion Detection System are a valuable addition to an organization's security infrastructure, there are things they do well, and other things they do not do well.

As we plan the security strategy for our organization's system, it is important for us to understand what IDSs should be trusted to do and what goals might be better served by other types of security mechanisms.

### Strengths of IDSs

IDSs perform the following well:
Monitoring and analysis of system events and user behaviors.
Testing the security states of system configurations
Base lining the security states of a systems, then attacking any changes to that baseline
Recognizing patterns of system events that correspond to known attacks
Recognizing patterns of activity that statistically vary from normal activity
Alternating appropriate staff by appropriate means when attacks are detected.
Measuring enforcement of security policies encoded in the analysis engine
Providing default information security policies
Allowing non-security experts to perform important security monitoring functions.

### Limitations of IDSs

IDS cannot perform the following functions:
Compensating for weak or missing security mechanisms in the protection infrastructure. Such mechanisms include firewall, identification and authentication, link encryption, access control mechanisms, and virus detection and eradication.
Instantaneously detecting, reporting, and responding to an attack, when there is a heavy network or processing load.
Detecting newly published attacks or variants of existing attacks.
Effectively responding to attacks launched by sophisticated attackers
Automatically investing attacks without human interaction.
Resisting attacks that are intended to defeat or circumvent them.
Compensating for problems with the fidelity of information sources
Dealing effectively with switched networks.

Although the system audits functions that represent the original vision, IDSs have been a formal discipline for almost fifty years, the IDS research field is still young, with most research dating to the 1980s and 1990s. Furthermore, the wide-scale commercial use of IDS did not start until the mid-1990s.

However the intrusion detection and vulnerability assessment market has grown into a significant commercial presence. Technology market analysts predict continued growth in the demand for IDS and other network security product and services for the foreseeable future.

Even while the IDS research field is maturing, commercial IDSs are still in their formative years. Some commercial IDSs have received negative publicity due to their large number of false alarms, awkward control and reporting interfaces, overwhelming numbers of attack reports, lack of scalability and lack of integration with enterprise network management systems. However the strong commercial demand for IDS will increase the likelihood that these problems will be successfully addressed in the near future. We anticipate that the improvement over time in quality of performance of IDS products will likely parallel that of antivirus software. Early antivirus software created false alarms on many normal user actions and did not detect all known viruses. However, over the past decade, antivirus software progressed to its current state, in which it is transparent to the users, yet so effective that few doubt is effectiveness.

Furthermore, it is very that certain IDS capability will soon become core capabilities of the network infrastructure and operating system. In this case, the IDS product market will be able to better focus its attention on resolving some of the pressing issues associated with the scalability and manageability of IDS products. There are other trends in computing that we believe will affect the form and functions of IDS products including the move to appliance-based IDSs. It is also likely that certain IDS pattern matching capabilities will move to hardware in order to increase bandwidth. Finally the entry of insurance and other classic commercial risk management measures to the network security arena will drive enhanced IDS requirements for investigative support and features.

### SUMMARY OF THE INVENTION

To be effective, a network security solution of any kind must be made up of several layers to address the various types of threats faced by today's computer networks. Intrusion detection systems will not pick up every attack, no matter what kind of system a company or individual has deployed. If only signature IDS are deployed throughout the computer network, they will not pick up new attacks. Since protocol anomaly systems can detect many new attacks like Code Red, Code Red II, and Nimda, corporations should, at minimum, be able to strengthen their defenses at the gates to their networks; at the Internet connection, VPN connections, customer network connections, and so on. Thus they bolster the first line of defense at the entry-points so that these attacks can be detected as soon as possible.

As is apparent to one of skill in this field, current firewall, software and internet security appliances and devices on the market today are not 100% effective in protecting from outside attacks, internally from malicious employee access or from third party IT contractor access to the network. They are also inefficient in terms of hardware, software and labor costs and could have a negative ancillary effect of slowing traffic on the respective networks due to filtering, causing bottlenecks, and latency issues.

The present invention addresses all of these issues in an innovative manner and is highly cost effective when compared to existing options. By simply plugging into any computer network infrastructure, the device, system, and method of the present invention scans traffic in an aggressive manner, independent of network traffic, grabbing snippets of information as it is in route, either from or going to the network. Because it is an inexpensive device, not a filtering device like most present IDS hardware and software methods, it doesn't create bottleneck or other filtering issues previously discussed.

Operationally, in one embodiment, the monitored samples of network traffic are analyzed and reports generated. When pre-configured negative indicators arise, an alarm is activated and timely notice is given to our NOC, network Operations Center or monitoring station, an immediate determination is made as to the severity and relevance of the network intrusion or problem by a fully trained IT security personnel on staff. False positives (valid traffic which is sometimes flagged as potential issues) are filtered out and when appropriate, the client is given detailed, timely notice of any potential issues via predetermined contact protocols. Thus, the monitoring package or sale of the present invention, allows clients to outsource related IT security costs in a more effective manner, eliminating the need for any business, home based or not, of having IT security personnel either on site or contracted, which monitors their computer network(s), freeing resources to address other aspects of running a business, regardless of size and location.

In one embodiment, the present invention is a system, software or method, and device that employs the use of honey pots, identifying and trapping would be attackers before they've had an opportunity to cause any or excessive damage to the computer network or gain access to large amounts of proprietary or confidential information. These traps speed up the detection process that may otherwise go hours, days, weeks, months or years before present devices alert someone of an intrusion.

The present invention is configured as a replacement to existing IDS hardware or software systems being used, increasing operational security and detection of potential third party attacks, while at the same time reducing costs and eliminating network performance, bottleneck and latency issues.

### BRIEF DESCRIPTION OF THE SEVERAL VIEWS OF THE DRAWINGS

FIG. 1 is a graph of a family of hypothetical ROC curves, each representing a classifier.

FIG. 1A is a graph of a family of hypothetical ROC curves, each representing a classifier.

FIG. 2 flowchart showing configuration of one embodiment of the present invention.

FIG. 2A is a graph of a expected cost vs. Probability of detection.

FIG. 3 is flowchart showing configuration of one embodiment of the present invention showing the reporting phase.

FIG. 3A is a graph of expected cost vs. Probability of detection using SCIT+IDS.

FIG. 4 is a flow chart showing network configuration.

FIG. 4A is a graph of expected cost vs. Probability of detection.

FIG. 5 is a graph of expected cost vs. Probability of detection.

FIG. 6 is a graph of expected cost vs. Probability of detection.

FIG. 7 is a graph of expected cost vs. Probability of detection using SCIT+IDS.

### DETAILED DESCRIPTION OF THE PREFERRED EMBODIMENT

Although persons skilled in this field understand terms used herein, the present invention contemplates the following definitions of terms used herein:

### IDS Terminology

Alert/Alarm: A signal suggesting that a system has been or is being attacked.
True Positive: A legitimate attack which triggers an

IDS to produce an alarm.
False Positive: An event signaling an IDS to produce an alarm when no attack has taken place.
False Negative: A failure of an IDS to detect an actual attack.
True Negative: When no attack has taken place and no alarm is raised.
Noise: Data or interference that can trigger a false positive.
Site policy: Guidelines within an organization that control the rules and configurations of an IDS.
Site policy awareness: The ability an IDS has to dynamically change its rules and configurations in response to changing environmental activity.
Confidence value: A value an organization places on an IDS based on past performance and analysis to help determine its ability to effectively identify an attack.
Alarm filtering: The process of categorizing attack alerts produced from an IDS in order to distinguish false positives from actual attacks.
Attacker or Intruder: An entity who tries to find a way to gain unauthorized access to information, inflict harm or engage in other malicious activities.
Masquerader: A user who does not have the authority to a system, but tries to access the information as an authorized user. They are generally outside users.
Misfeasor: They are commonly internal users and can be of two types:
   1. An authorized user with limited permissions.
   2. A user with full permissions and who misuses their powers.
Clandestine user: A user who acts as a supervisor and tries to use his privileges so as to avoid being captured.

The present invention utilizes the use of ROC (Receiver Operating Characteristic) curve based analysis, which is a powerful tool system administrator can use with enterprise specific data to build economic models and to compare alternate architectures.

SCIT (Self Cleansing Intrusion Tolerance) can be used in combination with IDS. SCIT is the approach favored in the present invention and is linked to intrusion tolerance which is classified in the recovery-based category.

From this assessment, optimal value(s) of Probability of Detection and other operational parameters can be selected to balance the potential damage from a missed intrusion and the cost of false positive processing. In our approach, we stipulate that providing an upper bound on the time between the compromise and recovery has many advantages since it does not require the assumption that the system will be able to detect either the intrusion attempt or the compromise.

### Intrusion Tolerance Approach (ITS)

ITS architecture objective is to tolerate unwanted intrusions and restore the system to its normal state. The recovery-based SCIT (Self-Cleansing Intrusion Tolerance) model, is applicable to servers that are open to the Internet, such as Web, and DNS servers. Using round-robin cleansing, at any point in time, a server in a SCIT cluster can have one of the three states: offline cleansing, offline spare and online transaction processing. The duration that a SCIT server is exposed to the Internet is called its Exposure Time. The architecture is simple, and does not rely on intrusion detection. Implementation of SCIT scheme can be based on virtualization. The interfaces between controller and the group of servers to be protected are trusted.

Another benefit of a recovery-based ITS, is to shrink down breach duration, which has the effect of reducing losses and their costs. Indeed, this intrusion tolerance strategy would mitigate the effects of malicious attacks. Intrusion detection is known to be a hard problem, and current cyber defense systems reportedly detect less than half the malware. Still servers and apps account for 98% of the total record compromised. Thus, current cyber defenses cannot protect systems against customized malware and other zero day attacks; once an attack is successful, it can persist for many weeks. This emphasizes the need for a recovery-based Intrusion Tolerance approach since detection triggered ITS might again fall short of the needs.

### Receiver Operating Characteristic (ROC)

ROC analysis has been long used in signal detection theory to present the tradeoff between hit-rates and false-positive rates of classifiers. ROC analysis was initially used during World War II in the analysis of radar signals to differentiate signal from noise. It was soon introduced in Psychology to map the perceptual detection of signals [10]. ROC curves are useful for assessing the accuracy of predictions. A ROC curve plots the fraction of true positives (hits) versus the fraction of false positives, and hence has a direct relationship with diagnostic decision making. The ideal prediction method would yield a co-ordinate (0, 1) on the ROC curve. This represents 100% true positives and zero percent false-positives, and is referred to as the perfect classification.

### Using ROC to Assess IDS Quality.

The most attractive feature of ROC analysis is the fact that the tradeoff between probability of detection and probability of false positive can be derived directly. This allows a system administrator to instantly determine how well a classifier performs and also to compare two classifiers. The present invention further addresses false positives in addition to the probability of detection since there is a need to characterize human workload involved in analyzing false positives generated by traffic. False positive rates above 100 per day could make IDS almost useless even with high probability of detection since security analysts must spend hours each day investigating false positives.

The present invention includes a methodology to compare various ID's, each of which is represented by a ROC curve.

The present invention is configured to address:
Determining appropriate units of analysis. Unit of analysis is the quantity of input on which a decision is made. The present invention considers a simple system and consistently use query/packet as our unit of analysis across all IDS's.
Errors per unit time. A pseudo-ROC curve with x-axis as False Positives per day instead of Percentage False Positives was used. This led to two incomparable units being used on two axes, and the results in turn became strongly influenced by factors like the data rate that should typically be irrelevant. The configuration of the present invention consistently use probability of detection and that of false positives for all ROC curves.
The emphasis is not on constructing ROC curves but on comparing IDSs using our cost-model once we have their respective ROC curves. While there is a need for alternative taxonomies, the scoring method from the attackers perspective is still utilized for real world incidents.

In order to be able to compare multiple IDS systems, the ROC curves should be generated using similar or preferably same test data.

The present invention utilizes a cost-model for the calculation of expected cost of operating at any point on the ROC curve.

### Cost Model

A cost model is used that consists of two elements:
A formula for the expected cost of operating at any point on the ROC curve
Cost metrics derived from published breach investigation reports

### Expected Cost Calculation.

The cost of operating IDS at any point on the ROC curve (Pf, Pd) is a combination of the following:
Operational Costs—Cost involved in operating the IDS and keeping it running.
Damage Costs—the amount of damage caused by an intruder in case of a successful attack.
Response Costs—the cost involved in responding to a potential intrusion on detection.

Out of the three costs mentioned above, operational costs and response costs greatly vary from organization to organization based on a number of factors like size of the organization, type of organization etc.

Expected Cost of operating at any point on the ROC curve=Cost of Misses+Cost of False Positives.

Thus, for every point on the ROC curve (Pf, Pd), we have an expected cost:

Expected Cost=(Cm*p*Pm)+(Cf*(1−p)*Pf),

where
Cm—Cost of a miss p—Prior probability of Intrusion
Cf—Cost of a false positive Pd—Probability of detection
Pm—Probability of a miss=(1−Pd)
Pf—Probability of a false positive

Note that this expected cost is for one incoming query. If there are “n” incoming queries, the above expected cost must be multiplied by “n”. The value of metrics used in the cost model is summarized in Table 1.

TABLE 1
Metrics Values Use in the Cost Model

| Metrics | Value | Explanation | Reference |
|---|---|---|---|
| Median | 1,082 | In cases of outliers this is a | [9] |
| number of | | better representation of the | |
| records lost | | “typical value” | |
| per breach | | | |
| (M) | | | |
| Average cost | $204 | Direct Cost: $ 60 | [16] |
| of a data | | Indirect Cost: $144 | |
| breach per | | | |
| compromised | | | |
| record (D) | | | |
| Cost of a | $220,000 | (Median number of records lost | [9] and |
| Miss (Cm) | | per breach) * (average cost of a | [16] |
| | | data breach per compromised | |
| | | record) = 1082 * $ 204 | |
| Cost of a | $400 | Assumption: Labor Cost + | |
| False Alarm | | Overhead Cost = $ 400 | |
| (Cf) | | | |
| Median | 14 days | Median time spent from System | [9] |
| Compromise | | compromise to Breach | |
| (Duration per | | discovery + Median time | |
| breach) | | spent from Breach Discovery to | |
| | | Breach Containment | |

The probability of detection Pd and that of a false positive Pf will constitute the operational parameters.

We use the median number of records lost for assessing damage. In many cases, the outliers in breach data can skew the data, because most of the losses come from only a few breaches. Therefore, the Mean becomes highly skewed and is not a good estimate of the typical number of records lost per breach. Median is a better estimate of the typical value.

### Evaluating Classifiers Using a Cost Model.

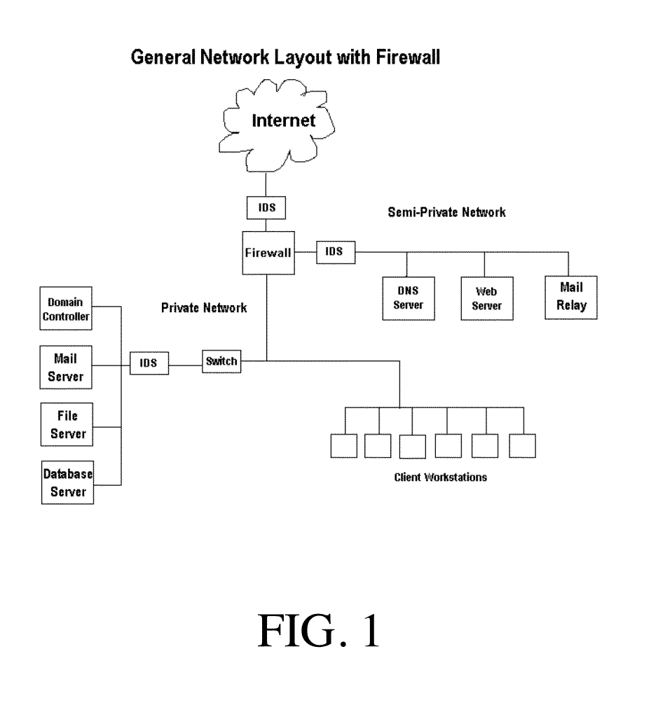

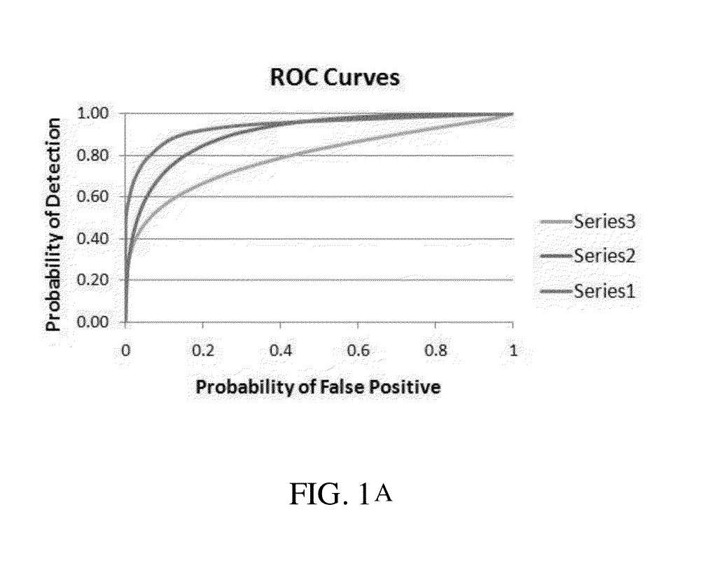

The invention described herein demonstrates how the cost model can be implemented once they are constructed. FIG. 1—Receiver Operating Curves, gives a family of hypothetical ROC curves, each representing a classifier. The cost model on these ROC curves in three different cases to evaluate the classifiers behaviors.

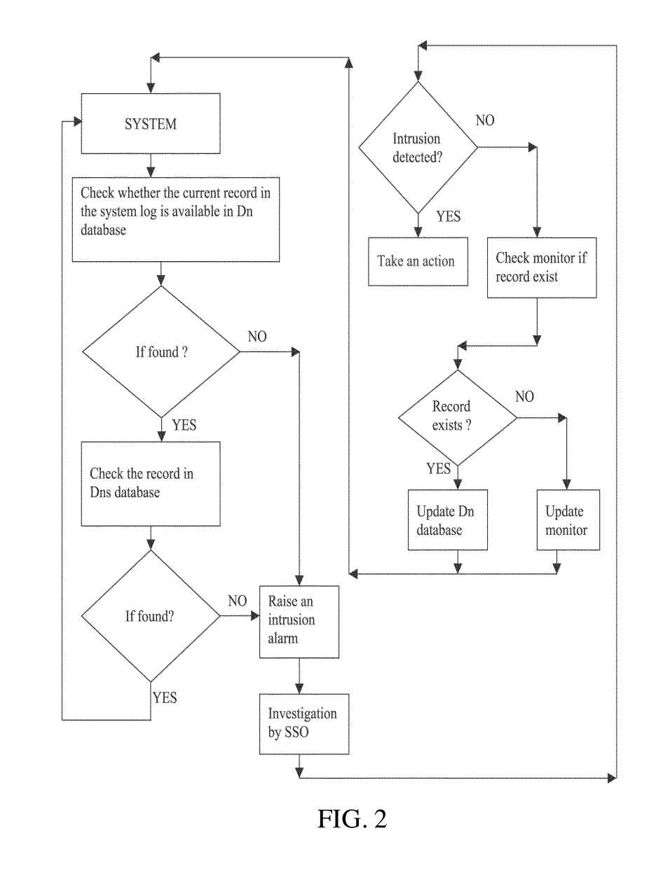

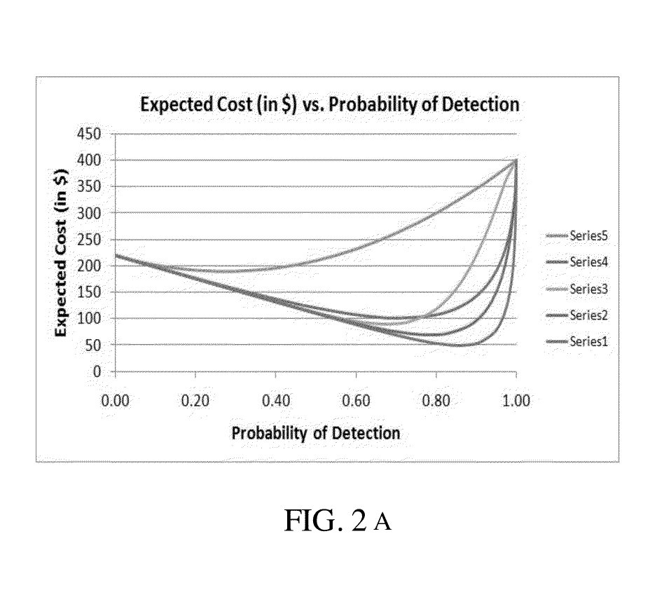

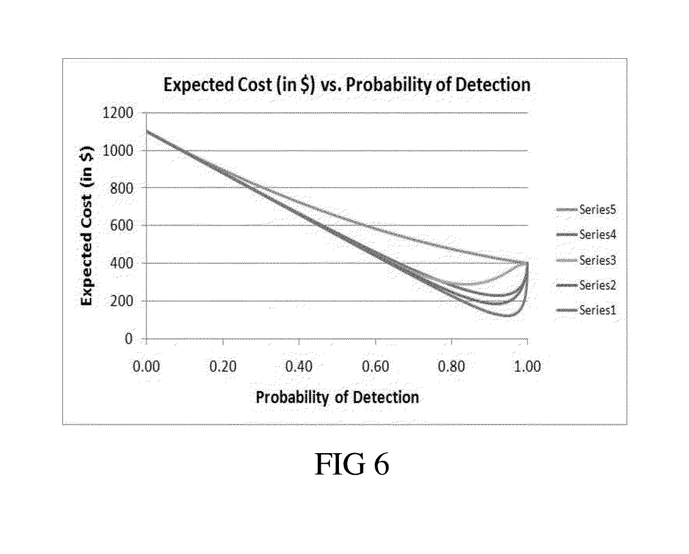

Table 2 provides the values of the parameters used in the cost model in each of the three cases. Within each case, the value of “p” remains the same for both IDS and SCIT+IDS. Therefore, the number of intrusions that occur in each of these architectures are the same since Number of intrusions=[Number of incoming queries*Prior probability of intrusion (p)]. The baseline IDS and SCIT+IDS scenarios are provided for Case 1. Case 2 and Case 3 help investigate the impact of “Cm” and “p” on system cost and security. FIGS. 2 through 7 illustrate this. It is noted that the y-axis scale is different in FIG. 6.

Case 1a. IDS: (FIG. 2)

This is a stand-alone IDS system. The cost keeps decreasing as Probability of Detection (Pd) is increasing, as shown in FIG. 2. As Pd increases, number of misses decrease along with the significant associated costs. However, after a threshold, if we keep increasing the value of Pd, the expected cost stops decreasing and starts increasing rapidly. At this point, the cost of False Positives exceeds the cost of misses and so the gains from containing misses start diminishing. This point is known as the “minimal cost point on the ROC curve (MCP)”. For e.g., in Case 1a, the MCP for Series 1 is 70 and it occurs at (Pf, Pd)=(0.20, 0.85). MCP for each series of every case we evaluated is tabulated in Table 3.

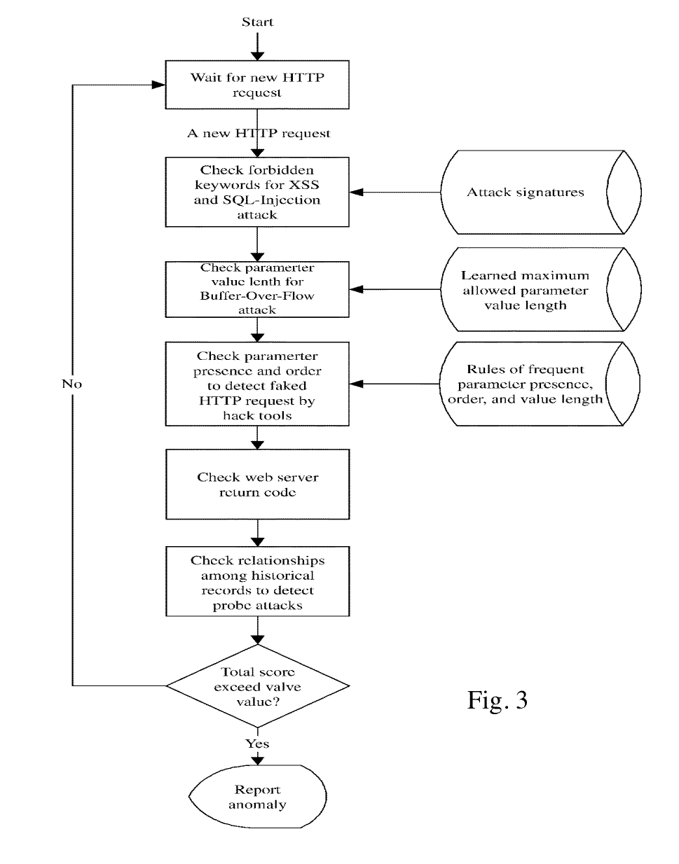

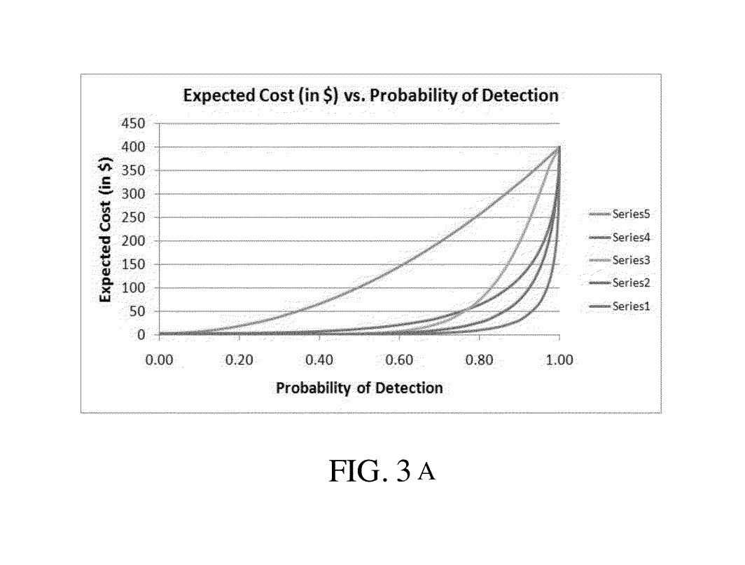

Case 1b. SCIT+IDS: (FIG. 3)

This figure demonstrated a result by adding SCIT to existing IDS and evaluate the system using our Cost Model. This assumes that the exposure time of SCIT is 4 hours. This reduces the compromise duration of the system from 14 days to 4 hours. A further assumption of this data is ex-filtrated uniformly over time. Since the cost of a miss was $220,000 earlier with compromise duration of 14 days, now it significantly reduces to $2,620 for compromise duration of 4 hours.

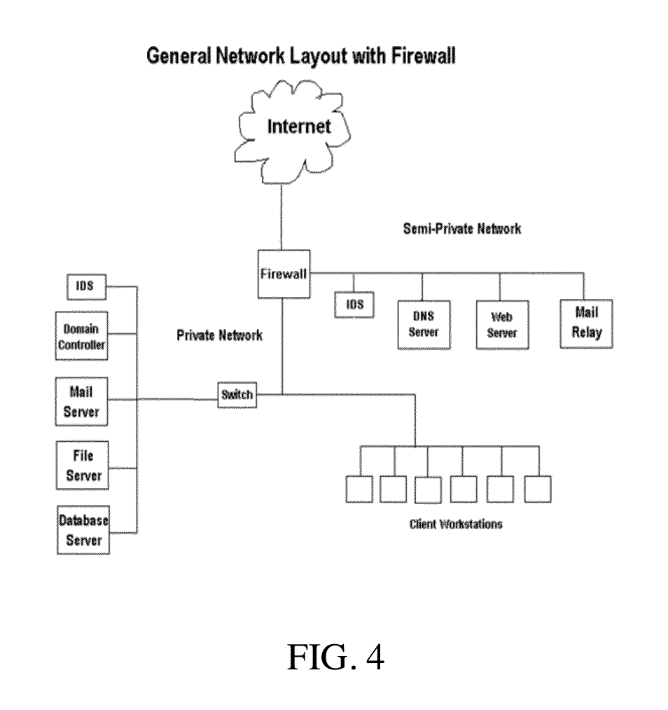

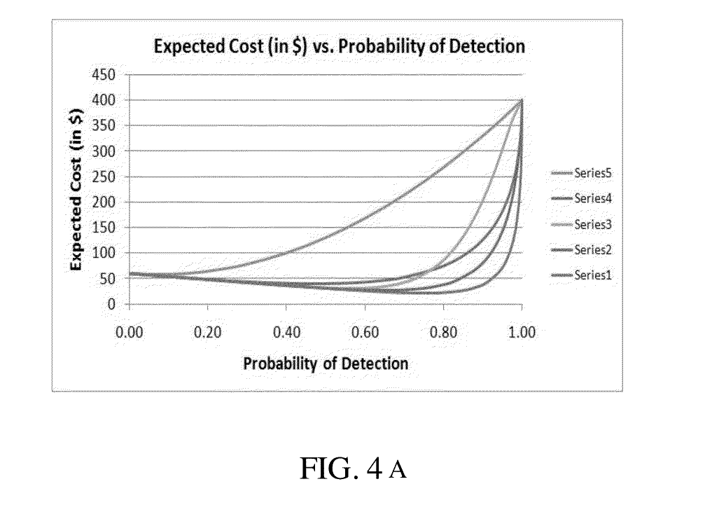

### Case 2. (FIGS. 4 & 5)

Assumption: As compared to the baseline (Case 1), IDS cost of a miss is reduced from $220,000 to $60,000.

FIG. 4 is IDS: Case 2a

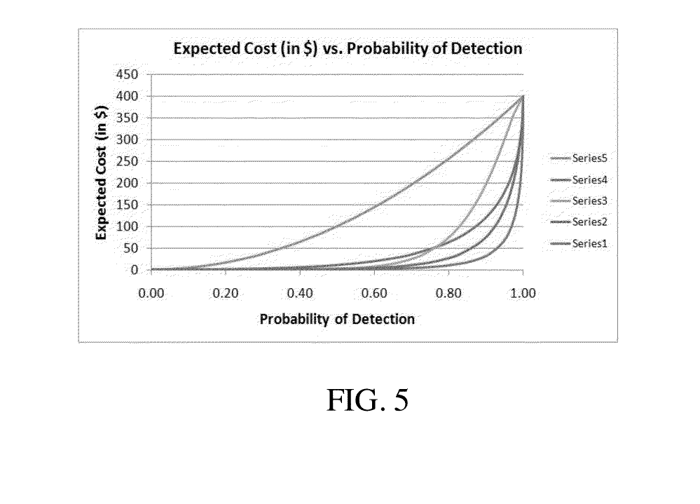

FIG. 5 is SCIT+IDS: Case 2b

### Case 3. (FIGS. 6 & 7)

Prior Probability of Intrusion is increased fivefold from p=0.001 to p=0.005.

FIG. 6 is IDS: Case 3a

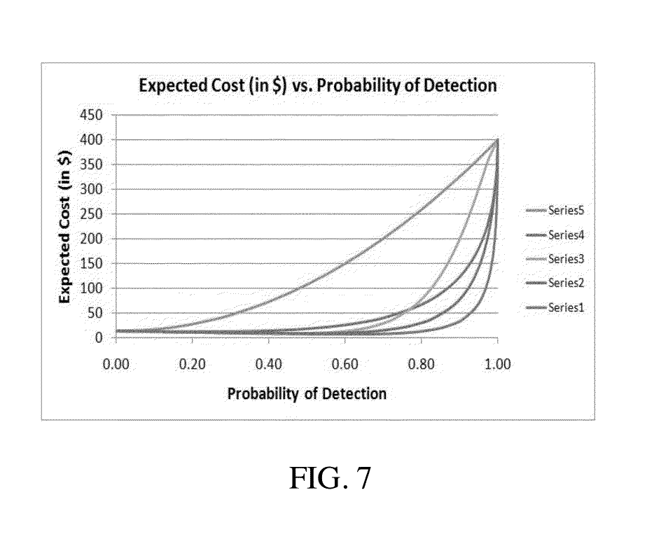

FIG. 7 is SCIT+IDS: Case 3b

TABLE 2
Parameter values used in the cost model

| | | | | Compromise |
|---|---|---|---|---|
| | P | Cm | Cf | duration |
| Case 1a: | 0.001 | $220,000 | $400 | 14 days |
| IDS | | | | |
| Case 1b: | 0.001 | $2,620 | $400 | 4 hours |
| IDS + SCIT | | | | |
| Case 2a: | 0.001 | $60,000 | $400 | 14 days |
| IDS | | | | |
| Case 2b: | 0.001 | $715 | $400 | 4 hours |
| IDS + SCIT | | | | |
| Case 3a: | 0.005 | $220,000 | $400 | 14 days |
| IDS | | | | |
| Case 4a: | 0.005 | $2,620 | $400 | 4 hours |
| IDS + SCIT | | | | |

### Results: Comparison of IDS's.

FIG. 8 compares the MCPs of 3 IDSs whose performances are indicated by the ROC curves in FIG. 1.
Series 1 IDS clearly outperforms all the other IDS in all three cases.
It is most expensive to operate the IDS in case 3 since prior probability of intrusion is high which in turn leads to more misses.

### Results: Comparison of SCIT+IDS's

FIG. 8 also presents the minimal cost points for IDS+SCIT. We have used an exposure time of 4 hours. We note that as compared to the IDS only case, the costs are much lower. The minimal cost points are achieved using a much lower value of Probability of Detection which in turn leads to a lower Probability of False Positive. We conclude that this makes the IDS design much easier and the system easier to operate. The reliability of the IDS results also increase.

From the results, we can see that the benefits of adding SCIT are as follows:
Cost of a miss is greatly reduced. As the compromise duration/exposure time of SCIT is reduced, cost of a miss further reduces.
The present invention tolerates a larger number of misses now that the cost of a miss is reduced.

### Roc Curves

General Observations (IDS and SCIT+IDS)
As the cost of miss decreases, we can tolerate more misses and so probability of detection for achieving minimal cost point can now take lower values.
As Cm decreases, Cf has a greater influence on the expected cost and so there is an increased need to contain false positives. Note that the Probability of False Positives for achieving minimal cost point now decreases.

As prior probability of intrusion ‘p” increases:
The total number of misses increases and so does the expected cost.
To combat this, probability of Detection for achieving minimal cost point increases thus reducing the number of misses. (Note: Number of misses=Number of incoming queries*p*Pm).

TABLE 3
Minimal Cost Point Values

| | Minimal Cost Point for FIG. 1 ROC - Cost ($) | | | | | |
|---|---|---|---|---|---|---|
| | series 1 | | series 2 | | series 3 | |
| | IDS | IDS + | IDS | IDS + | IDS | IDS + |
| CASES | only | SCIT | only | SCIT | only | SCIT |
| CASE 1 | 70 | 2 | 102 | 3 | 135 | 3 |
| CASE 2 | 28 | 0.5 | 43 | 1 | 45 | 1 |
| CASE 3 | 170 | 7 | 218 | 12 | 386 | 12 |

Intrusion detection is a hard problem, making intrusions inevitable. Consequently, containing losses by an upper bound on the time between compromise and recovery shows many advantages. ROC analysis, supplemented with cost analysis using median of lost records and average cost of compromised records per breach, reveals tradeoff between high probability of detection, and low probability of false positives. Our approach reduces the cost of a miss; and tolerating a larger number of misses” leads to lower false positive costs.

The SCIT architecture provides a robust security mechanism that guarantees certain security properties by limiting the exposure time. In addition, SCIT does not generate false positives and thus reduces the intrusion alerts management costs. Thus SCIT also provides administrative and economic benefits which make it a reasonable choice to be included in security architecture. In particular, this is expected to be of interest in environments where technical skills are limited. The analysis presented suggests that a combination of IDS with SCIT on host servers provides a robust architectural solution in the face of new attacks.

When most people think about “Defense in Depth” on Internet-attached networks, they typically think of routers, firewalls, and Intrusion Detection Systems (IDSs). One other layer of defense in depth can be achieved through the use of Honeypots to gain direct, observable knowledge of how Black Hat hackers operate.

One approach to provide the desired security is utilization of a honeypot.

Honeypots are designed to look like a system. An intruder would like to hack and are installed on an Internet segment that limits their ability to wreak havoc in other parts of your network or on other systems; Honeypots can be installed inside, outside, or within the firewall DMZ. For control reasons, most honeypots are integrated inside the firewall.

Firewall policies for honeypot systems are virtually opposites of what a firewall is designed to do. Rather than being restrictive on what comes in via the Internet and less restrictive on what goes out, the firewall rules for a honeypot system should permit all traffic in from the Internet and block most outgoing traffic to the Internet to limit damage. The idea here is to attract the adversary while containing their abilities to use the honeypot as a stepping-stone to further attacks on other protected resources or on systems belonging to others on the Internet.

This works by presenting the hackers a foul scenario where a hacker thinks that he is penetrating into the system but instead, he is going nowhere, he is playing in the world created by the admins. By doing so, admins are able to check all the malicious activity of the hackers like what all ports hackers are trying to connect, what files they are trying to upload, which all sections they are trying to access. Honeypot is mainly designed to trap the hackers, or present a virtual system to the hacker that never exists. Technically, Honeypot tries to listen to all the ports on the system, and whenever hacker tries to port scan the system, it gets a list of open ports which he thinks are open but actually, it is the open port which is shown by the honeypot behind the firewall, so when any hacker tries to access some random port say 100, then he is actually accessing the honeypot not the system.

### Creating a Honeypot

Honeypots can operate on any variety of computer Network systems—often an unused PC will do. While most public domain software for setting up a honeypot is written for UNIX, many of these systems have already been ported to NT. Additionally; configured systems will need a sniffer package to keep tabs on traffic leading to the Honeypot segment.

There are mainly 3 types of honeypots available:—

1. Small: Mainly keeps the log of IP-address which are trying to access your system along with the port

2. Medium: Its functionality is little advanced, keeping track of files accessed, time-period, hosts etc.

3. Large: It provides a the functionality, but the main feature of these kinds of Honeypots are the security features, these can simulate virtual OSes for the intruders very well.

### Software:

Several commercial software systems are available for building and operating a honeypot system, along with an even wider variety of shareware or public domain programs easily found on the Internet. Some of today's commercial systems include, but are not limited to:

Deception Toolkit from Fred Cohen and Associates Man Trap by Recourse Technologies

Cybercop Sting by Network Associates

Specter by Specter Technologies

Tripwire from Tripwire Inc.

Honeypot systems should be configured to look like a box that a Black Hat would like to exploit. You can achieve this by giving it an irresistible name, like intranet.companyname.com or mail.companyname.com. If there's any telltale signs that your system is other than a legitimate host, the hacker will likely know that something is up and quickly leave—defeating the purpose of installing one in the first place!

### The Goals for Honeypots:

Learn how intruders probe and attempt to gain access to your systems. The general idea is that since a record of the intruder's activities is kept, you can gain insight into attack methodologies to better protect your real production systems.

Gather forensic information required to aid in the apprehension or prosecution of intruders. This is the sort of information often needed to provide law enforcement officials with the details needed to prosecute. More important, when you decide you're going to build a honeypot you must first realize that you're playing with fire and can easily get burned. Someone with skills far superior to your own is out there and poised to attack your system and it may only take them a few hours after it's up to discover it! Keeping this in mind the entire way through is your best hedge against doing something reckless—or even fatal.

Ultimately, the objective is to boot the attacker off the system once sufficient logging of activities is accomplished, wiping the system clean, patching the vulnerabilities that were exploited, and bringing the system back up for the next Black Hat. Most advanced Honeypots use layers of logging functions to prevent losing valuable information if the hacker erases it. Furthermore, it places the log files on a separate, protected server while making it appear as though logging is occurring locally.

Again, the more deceptive the system is, the better! During the security Phase of a compromise, you watch the Black Hat for a few days once root is compromised before booting him off. Doing this provides more information about the hacker's activities or helps to gain additional forensics to prosecute him once he's caught. Sometimes, the goals of putting up a honeypot are purely academic in hopes of learning as much as possible and fixing as many exploits as possible to increase your security posture. Not all honeypots need be used for prosecution purposes, but be sure your goals are clear before you set out to build one, because evidence handling is no trivial matter.

Honeypots may be useful as a crash course in hacking, and are currently being used by some of the commercial training programs, like the Ultimate Hacking: Hands On course by Foundstone.—Since one can establish a honeypot anywhere on your network, one might want to learn more about your insider threats. Because firewall rules and policies differ widely on an intranet vs. the Internet, one can place a honeypot on an isolated network segment that's only accessible from the private network. One may find that you have far more rogue employees in an organization. In these cases, make certain to involve information security personnel and human resources department to determine the next steps once you catch an insider ne'er-do-well.—Finding skilled White Hat hackers is becoming increasingly difficult every day and a honeypot-type system can be a valuable training ground for recruits to a White Hat staff of professionals. One might consider setting up a honeypot with known sets of vulnerabilities and give prospective employees sufficient time and access to try and find one or more exploits and take control of the system. There's likely no better “acid-test” for weeding out these people who can't provide you with sufficient confidence that they can ward off the real attackers.

Most of the information about honeypots originates with the military and former military personnel, but there's understandably little out there in the way of case studies on specific honeypot users. The point here is that to any casual observer a honeypot is just another box that's subject to an attacker's whim. Advertising the presence of the honeypot defeats the purpose so be very careful to whom you blab to about it!—

### Uses of Honeypots

### Bait

The simplest use for a honeypot is to act as bait. If you know (or believe you know) that a hacker or malicious program will attempt to target your computer, then a honeypot can be set up as bait. For instance, let's say that you wanted to protect your computer against a hacker that liked to cause mischief in file transfer programs. You would set up a honeypot to act as a dummy file transfer program, and your computer would direct the hacker to the honeypot where he would be taken in by a program that, while it might look real, not in fact what he's looking for.—

### Monitor

Another use for a honeypot is as a monitor. Let's say that you wanted an additional security program on your computer to monitor a certain area of activity. You put a honeypot there and leave it. Then you check back on periodically and read the logs to see if there's been any activity. While the honeypot's purpose of being a distraction hasn't changed, you're now using it as an active security monitor, rather than as a passive lure to suck malicious programs and computer users off course and into a place where they can't do any real harm to your system.—

### Information Gathering

A honeypot also has the potential to get a hacker to betray herself throughout her interaction with it. For instance, let's say that you set up a honeypot as a trap rather than as a simple lure. The hacker gets into a system and begins interacting with the honeypot program. By observing how the hacker works, what programs they attempt to use and even where the hacker's connection is coming from. A honeypot may give you enough information to backtrack the hacker and to find out who they are and from where they're operating.

### The Risks:

Obviously if a honeypot is successful then one thing is perfectly clear—there are hackers on a network and they're poking their way through it. Now what? One of the foremost dangers you must guard against is that a honeypot will be used as a launching pad to further attacks on you or on others via the Internet. With proper firewall rules one is able to limit this risk. Another risk is how to carefully balance the control over the hacker without limiting them too much to the point they discover they're being watched. Here's where the excitement builds—playing cat-and-mouse with a skilled computer criminal.

### Maintenance of the Honeypot:

Like any other server, honeypots must also be maintained to assure that old holes are patched and that logging is working properly. Failure to maintain the system—or worse forgetting that it's there—is akin to leaving a gaping hole in your network. This includes the need to maintain your incident response procedures as people come and go and pager numbers change.—

### Entrapment or Good Security Practice?:

Some people believe that setting up a honeypot is a form of entrapment and that evidence collected from it will be inadmissible in court. Others believe this is simply not the case because honeypots are not designed as active lures. The only time a hacker should stumble upon the honeypot is through scanning activities that he conducts on his own. If you're careful with your forensics gathering and handling of the log information through a well-documented and well-practiced custody of control you should be able to use all the information for your own benefits.—It's also important to remember that you can't set-up a honeypot without the support of your organization and its management. You'll need their support and commitment before you begin, otherwise you may find yourself the target of an orchestrated attack by hackers who are miffed that you're trying to trap them. Should that occur, you don't want to stand alone trying to fend off their attacks.

### Low Interaction Honeypots

Low Interaction Honeypots are Honeypots that emulate only certain services and thus limit the attack vector space. They are useful because they cannot be compromised to attack other hosts. In low interaction Honeypots, vulnerable services are emulated by using special handlers and not the real service. This tricks malware that happens to be probing a port that the service runs on into interacting with the service and having itself copied into a safe place where it cannot replicate or compromise the host. There are many examples of low interaction honeypots including Dionea [5] and Honeytrap [6].

How exactly do low interaction honeypots actually trap a piece of malware? The first step of capturing the malware is to look for when a piece of malware tried to connect to a given TCP port. To understand this, we need to remember how the TCP Three way handshake works. The first step is for the TCP Server to bind to a specific port and start listening for connections. The client will send the server a TCP packet with the SYN bit set. This will then cause the server to send the client a SYN-ACK packet. Finally, the client will acknowledge this and send the server an ACK packet. Now what happens if a server is not in a listening state on that port and a client tries to connect? Well the server will send the client a TCP Reset (RST) which will tell the client to close its side of the connection. Low interaction honeypots such as HoneyTrap will sniff outbound packets for this TCP Reset. It will then intelligently start a listening service on that port. The next time the malicious caller attempts to connect, it will be successful. The other way HoneyTrap accomplishes this is by having ipTables send SYN packets to HoneyTrap directly so that it can open the corresponding port. Now that we have a connection open to the attacker, there are a couple of things that can be done. HoneyTrap emulates service responses by sending the client back the contents of local response files for a particular service. It can also either mirror the traffic back to the client to have it basically attack itself. Another interesting option is to have it work as a proxy to send the malicious traffic to another dedicated machine.

If HoneyTrap is running in Service emulation mode, all of the exploit data will be logged to the file system where it can be analyzed by a host of applications. There is also a suite of plug-ins available to analyze this stored data.

### High Interaction Honeypots

High interaction honeypots are typically complete systems running a full suite of services. They allow a high level of interaction with the attacker. None of the services being offered on these systems are emulated. The advantage of a high interaction honeypot is that you learn more about an attacker's actions especially in the reconnaissance phase of their operations. High interaction honeypots have their disadvantages as well. They are more difficult to instrument and they do carry much more risk in the event they are compromised. For instance, if the attacker is able to compromise this type of Honeypot and they launch an attack on another network from your Honeypot, you will be held liable. This risk is not present with low interaction Honeypots.

There are a few different options when considering construction of a high interaction honeypot. You may choose to use a physical high interaction Honeypot which is basically a well characterized server. You also have the option of using a virtual high interaction Honeypot. There are a few common ways to do this: User-mode Linux and VMWare. User-Mode Linux allows you to run multiple virtual Linux instances as processes on a host computer. VMWare will allow you to construct a virtual machine that is running an operating system of your choice on a host computer. This provides flexibility with respect to the operating system of the high interaction honeypot and also adds a layer of protection. What this means is that if an attacker is able to compromise the virtual machine, they are not attacking the native hardware platform. The other advantage of using a virtualized approach is that it is easier to revert to a “clean uncompromised” state. A final advantage of using a virtualized environment is that you can run honeypots of multiple operating systems on one hardware platform. This enhances your attack surface and allows for the collection of information on more attack vectors.

Once we set up a high interaction Honeypot, we need to start gathering attack intelligence. There are a couple of ways to get information from a Honeypot on how the attack occurred. The first is to examine the log files. This can be problematic because the first thing an attacker does is to either modify system logs or delete them altogether. For this reason, it is important to first set up the Honeypot to use distributed logging. This ensures that the logs cannot be erased easily [8]. The other piece of instrumentation that is useful is the use of a key logger. The command history that the attacker used in the exploit is useful. The other thing that is useful is an understanding of how they installed a rootkit. Typically, the login binary will be replaced with something that gives an attacker easy access to the system [8]. To learn which files that have been replaced by a rootkit, tools such as the TripWire file integrity checker are useful [9]. You should use tcpdump [10] to capture the packets that are entering and exiting the honeypot. Note that there should not be lots of traffic because by definition your high interaction Honeypot should only be getting malicious traffic. Kernel level information is also useful. For instance, by instrumenting a layer between user space and all kernel level system calls, we can without a doubt tract the attacker's actions. This is how the Sebek high interaction honeypot works [11].

TABLE 4
The pros and cons of High and Low Interaction Honeypots

| Honeypot Type | Pros | Cons |
|---|---|---|
| Low Interaction | Less Risk of Host OS | You need to be running |
| | Compromise | vulnerable services |
| | Lower Cost | which means running |
| | since typically | already known exploits |
| | software applications | Attack surface limited |
| | Scales to many hundreds | to the services you |
| | of instances well | are running |
| | Can capture malware | Limited understanding |
| | fairly easily | of hackers |
| | | reconnaissance |
| | | and other hiding |
| | | techniques |
| High Interaction | Simulates real world | High risk in the event |
| | conditions and helps | of compromise |
| | learn about unknown | Costly to implement |
| | attack vectors | on a large scale |
| | You can run multiple | due to hardware costs |
| | Operating systems | and resource |
| | on one physical host | requirements |
| | to increase coverage | Monitoring is more |
| | Can be as simple as | complicated since |
| | setting another host | more services are |
| | on your network | typically deployed |

### Honeynets

A honeynet is a network of honeypots that are characterized by a honeywall to divide parts of the honeynet from other parts of the network. The honeywall is a firewall that prevents malicious traffic from leaving the honeynet and attacking other networks [11]. When talking about Honeynets, there is often a differentiation between Gen 1 and Gen 2 architectures. Gen 1 Honeynets have a simplistic firewall to block outbound malicious traffic. In Gen 2 Honeynets, this firewall setup is more sophisticated so that it can actually manipulate outbound traffic to make it benign [11]. Honeynets capture three critical types of information about attacks which makes them very useful. First of all, there is a firewall log. In most cases, if ipTables is used as the Honeywall, these messages can be logged to /var/log/messages. Another piece of the data capture component of Gen 2 Honeynets is a packet sniffer to record all traffic coming in and out of the Honeynet. Since this is malicious traffic, we do not expect large volumes of packet capture. The final component is a kernel module like Sebek to record the hacker's actions in a way that happens after traffic has been decrypted [12].

### Detecting a Honeypot

It is important to understand how a Honeypot can be detected because savvy attackers will likely abort their mission if they believe they are being in a monitoring environment. Many malware now currently incorporate honeypot detection within their logic so that they will “self destruct” on Honeypot detection. This makes it more difficult to contain malware so that effective signatures can be developed for it.

One of the most popular ways to log the actions of an attacker in a high interaction honeypot is to use a tool called Sebek. Sebek is essentially a kernel module that can log keystrokes and operations to a log [13]. Sebek actually has two components to it: A kernel module and a server piece. The server piece is designed to run on the honeywall whereas the kernel module is loaded on the Honeypot itself. Sebek is essentially a kernel level root kit. The reason it is implemented this way is because hackers had started installing their own binaries to circumvent user space logging. Since Sebek is implemented in Kernel space, this is not modifiable by the user. Specifically, it replaces the default read( ) function in the system call table with a new version and has the new version funnel data to a data logger function. This approach is interesting because it even deals with encrypted shell sessions because data is decrypted by the time it reaches the Sebek read function. Sebek actually does use a few methods to obfuscate itself from the attacker. First of all, it installs a second kernel module that acts to remove Sebek from the linked list of installed modules [13]. Sebek also takes steps to hide the packets it sends from the honeypot to the server. The way it does this is it by generating its own packets and not even using the raw socket interface upon which libpcap is based. There is still a problem though where if two honeypots are installed on the same LAN, honeypot A would be able to see Sebek packets from honeypot B. Sebek circumvents this by installing its own Raw Socket implementation that silently ignores all Sebek packets. It is now clear that many of the obfuscation techniques that have been coded into Sebek have been broken. For instance, it is possible to detect kernel modules even if they have been cleaned [14]. This approach has to do with searching for the kernel module header structure which happens to still be in memory. Another way to detect Sebek is to look at the System Call Table on a host and to compare that to a normal configuration. This approach looks for modified function pointers. This just goes to show what many security researchers know are the limitations of Sebek as a high interaction honeypot. That being said, if the attacker is not savvy enough to look for evidence of the honeypot using these principles, it may still stay hidden. There are also even techniques to disable Sebek on the windows platform which make it even less desirable.

It is also possible to detect that a honeypot is running in a virtualized environment. The key thing to remember about running in a virtualized environment is that execution timing is altered because of the virtualization layer. For example, if you look at ICMP Echo response times between a virtual machine and a physical machine, there is a delay [15]. This is likely due to the fact that the packet traverses the TCP/IP stack of the virtual machine and not just the physical host machine. More instructions must be executed which therefore adds delay.

Another way that attackers can determine if they are in a virtualized honeypot environment is by using Execution Path Analysis. EPA is enabled by connecting the syscall handler (int 80) and the debug exception handler (int 1) in the IDT (Interrupt Description Table). Then, by setting the TF bit (mask 0x100) in the EFLAGS register, the new handlers are able to count each SIGTRAP generated when an instruction is executed [14]. This approach does have a few limitations in that the attacker needs high level privileges to execute these changes and also, the modification of the system calls are not covert [16].

Virtual machine detection can be done in other ways that namely examine, file and registry artifacts, running processes and directories [17]. It is also possible to examine memory to find evidence of a virtual machine. For example, in host machines, the interrupt descriptor table is in low memory while on the guest machine, it will be usually be higher in memory. This approach can be extended to look at the location of the GDT (Global Descriptor Table) and the LDT (Local Descriptor Table) in addition to the IDT (Interrupt Descriptor Table). The third way to detect a virtualized environment is to look for virtual hardware. In a Linux environment, one standard check is to look for VMware specific naming in the proc file system and also to look for well-known VMWare devices. Another interesting way to detect that you are running within a virtual machine is to look for Virtual Machine specific instruction support. Virtual machines support instructions that are not available on a host machine. These instructions are namely there to facilitate guest to host interaction. There are tools to discover this trait by attempting to execute the VM specific instructions and then seeing if their exception handler was triggered. If it was, then that means the instruction was not supported and we are executing on a host. If the exception handler is not triggered, it means that we are running in a VM [17].

The point with discussing how an attacker may detect a virtual machine is to shed some light on the sophistication of current malware. Many of the latest types of malware are able to exploit these detection schemes and not execute their most sensitive operations to prevent detection. These methods can and have been tightened up in many cases but are the evidence of a Honeypot that a hacker will look for after gaining access to a system. It really is a constant back and forth to hide virtual machines from the latest hacker detection technique. You should assume that the hacker knows everything that is written here because it is all publicly available information. Honeypots are no panacea for catching the bad guy but that does not mean they are not valuable.

### Detecting Zero Day Attacks Using Honeypots

One of the limitations of most cyber security technology is detecting the zero day threat. These threats have yet to be characterized and thus are not part of the rules of any security vendor's threat database. Honeypots can help in detecting these threats. This section of the article describes the latest work with respect to detecting zero day attacks. Some of the latest malware is self replicating and mutating. This means that it does not fit into readily defined signatures. Honeypots can help us characterize and protect against this threat.

Some interesting work is being done to determine how to detect zero day threats by using Virtual Honeypots. The Argos Emulator for capturing Zero Day Attacks is virtual high interaction honeypot [19]. Argos employs QEMU which is an open source emulator and virtualizer and uses an idea called Dynamic Taint Analysis to determine when network traffic is executed. If you think of what a zero day attack is, it is basically when network traffic payload ends up being executed on the host. A processor's conventional control flow is diverted by the attacker and code that they have injected is executed, which often launches a shell for the attacker to login and compromise the system. Argos tries to detect these instances [20]. By correlating the network traffic with information logged by the QEMU emulator, Argos is also able to generate intrusion detection signatures to prevent the attack which are immune to changes in the payload which means they cannot be manipulated to produce an undetected variant. This approach apparently has very low false positives [20].

### Latest Trends in Honeypot Architectures

Antivirus companies have been using Honeypot and Honeynet technology to capture and produce signatures for malware for quite some time. For instance, Avira has deployed a distributed Honeynet to capture and analyze malware samples. The problem they had faced was that malware tends to try and infect hosts with similar IP addresses because there is a higher probability that the IP will have been allocated. The Avira Honeynet was a low interaction Honeypot which emulated various vulnerabilities to gather worm variants that used that particular exploit. These samples are transported from various clients to a centralized server for further analysis [18]. This is an example of a distributed Honeynet. Taking this idea a step further is the use of cloud computing concepts for Honeynets. This is interesting because it is couples the virtual machine based aspects of virtual Honeypots with this distributed data collection architecture described by the work done at Avira and others. This is the future [21]. The other issue that cloud based honeypots address is that as data migrates to the cloud, cloud based security is becoming more critical. For instance, many cloud customers would like to ensure that their virtual instances have not been compromised. Some researchers have proposed what a cloud based Honeypot architecture would be. It is not public at this point whether Amazon EC2 or RackSpace have implemented a Honeypot as a service since it is not currently listed on their sites. Amazon web services does detect when port scanning is happening and it is explicitly against their acceptable use policy, however it is not clear what tools they use to detect it [22]. Further, it is apparently not possible for one tenant of the Amazon Web Services to sniff the traffic of another tenant by putting their Virtual Machine in promiscuous mode because the hypervisor will not deliver frames to them. Even two virtual instances owned by the same customer cannot listen to one another's traffic [22].

Honeypots come in many different varieties which each have their own pros and cons. They are very valuable tools for finding network attacks that otherwise go undetected with conventional network security tools. Distributed Honeynets, cloud based Honeypots and Honeypots running in emulated environments to detect zero day attacks are interesting areas that should be monitored closely for their future contributions to improving network security.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A method of providing computer network security, said method comprising the steps of:
providing programs on a non-transitory computer readable medium, said programs configured to monitor network traffic and computing activity on a computer network;
configuring said programs with an actuation threshold, wherein said actuation threshold is triggered by an event associated with unauthorized access to the computer network;
actuating said programs in a manner to direct an unauthorized user to at least one pre-selected file of said network;
forming at least one computer system decoy, wherein said decoy receives the direction of the unauthorized user;
notifying an authorized computer user of the actuation of the program.

2. The method of claim 1 wherein said programs monitors network usage and traffic.

3. The method of claim 1 wherein said method further includes utilization of a central monitoring station whereby more than one computer system utilizing the method is monitored for actuation.

4. A computer system configured to implement the method of claim 1.

5. A device having stored thereon programs on a non-transitory computer readable medium, said device constructed and arranged to connect to a network and implement the method of claim 1.

6. A system of providing computer network security comprising:
at least one program on a non-transitory computer readable medium, said program configured to monitor network traffic and computing activity on a computer network;
said program having an actuation threshold, wherein said actuation threshold is triggered by an event associated with unauthorized access to the computer network;
said program configured with directing means to direct an unauthorized user to at least one pre-selected file of said network;
at least one computer system decoy, wherein said decoy receives the direction of the unauthorized user;
notifying means whereby an authorized computer user is notified of the actuation of the program.
